(19) United States
(12) Patent Application Publication
(10) Pub. No.: US 2011/0009512 A1
(43) Pub. Date: Jan. 13, 2011

(54) REDUCTION OF ALDEHYDES IN AMINES

(75) Inventors: Robert A. Grigsby, JR., Spring, TX (US); Ernest L. Rister, JR., Round Rock, TX (US); Wei-Yang Su, Spring, TX (US); Eugene P. Wiltz, JR., The Woodlands, TX (US); Robert B. Moore, Leander, TX (US)

Correspondence Address: HUNTSMAN PETROCHEMICAL LLC, 10003 WOODLOCH FOREST DRIVE, THE WOODLANDS, TX, 77380, US

(73) Assignee: Huntsman Petrochemical LLC, The Woodlands, TX (US)

(21) Appl. No.: 12/919,817

(22) PCT Filed: Mar. 18, 2009
(86) PCT No.: PCT/US09/37499

§ 371 Date: Aug. 27, 2010

Related U.S. Application Data
(60) Provisional application No. 61/038,167, filed on Mar. 20, 2008.

(51) Int. Cl. C08J 9/228; B01J 31/02

(52) U.S. Cl. 521/94; 502/167

(57) ABSTRACT

A tertiary amine, such as a tertiary amine catalyst that is useful in the production of polyurethanes, may undergo decomposition, which may result in the production of undesirable products. These tertiary amines, however, may be treated with a primary amine containing material to reduce the presence of the undesirable products to an acceptable level. Thus, a foam made from a treated tertiary amine will also have a reduction in the presence of the same undesirable products.

### CROSS-REFERENCE TO RELATED APPLICATIONS

This application claims the benefit of U.S. Provisional Application No. 61/038,167, which was filed on Mar. 20, 2008.

### FIELD OF THE INVENTION

This invention relates generally to catalysts useful in making foams, and more particularly to amine catalysts and polyurethane foams, both having a reduced aldehydes and odor content.

### BACKGROUND

New standards and regulations for foam plastics allow very low amounts of aldehydes, such as formaldehyde, and dimethylformamide in foams. For example, both United States and European polyurethane foam-manufacturer trade groups are in the process of adopting the “CertiPUR” program, which is a voluntary program, to advance the safety, health, and environmental performance of polyurethane foams. The CertiPUR program seeks to do this by setting standards that restrict or prohibit certain substances.

One substance targeted by the CertiPUR program is formaldehyde and another is dimethylformamide (DMF). According to the CertiPUR standard, the limit for formaldehyde emissions is 0.1 mg/m³ when tested using the ASTM Method D5116-97 Small Chamber Test with chamber conditioning for 16 hours. Another test method is the European chamber test, which allows 5 micrograms DMF or formaldehyde per cubic liter in fresh foams and less than 3 micrograms per cubic liter in foams that are greater than 5 days old.

Since formaldehyde and DMF are targeted by the CertiPUR program it is desirable to have as little formaldehyde and DMF as possible in the raw materials that are used to produce foams. Raw materials may include amines such as tertiary amine catalysts. Freshly distilled amine samples typically show 10 parts per million (ppm) or less formaldehyde by LC analysis, but samples of amines taken from the laboratory shelf may contain from 10 ppm formaldehyde to even a 1000 ppm formaldehyde depending on the age and storage conditions of the amines. The formaldehyde found in amines may be derived from a variety of sources—it may be present as a contaminant from the manufacture of the amines, it may result from the oxidation or free radical attack of various carbon segments of a tertiary amine, or it may be present in the non reduced form on the methyl amine group as a Schiff base or aminomethanol (hydroxyl amine) group.

Without being bound by theory, DMF in tertiary amines is believed to be produced from aldehydes, such as formaldehyde, via the Cannizzaro reaction. According to this reaction, aldehydes lacking an α hydrogen atom that are in the presence of concentrated alkali undergo self-oxidation and reduction reactions to yield a mixture of an alcohol and salt of a carboxylic acid. The Cannizzaro reaction can occur at room temperature with concentrated aqueous or alcoholic hydroxide. For example, two formaldehydes in 50% NaOH yield one methanol and one sodium formate.

Because most tertiary amines are strong bases, the Cannizzaro reaction may occur at room temperature to yield methanol and formic acid, which forms a salt with methyl amines (methyl amines may be another decomposition product found in tertiary amines). This proceeds to form DMF, which is a prohibited substance under section 5 of the CertiPUR Standard as it may cause cancer and it may cause damage to an unborn child.

Thus, there is a need for polyurethane foams and the materials used to make the foams that have a reduced amount of restricted substances.

### DETAILED DESCRIPTION

According to an embodiment of the present invention, tertiary amines that contain primary amines, primary amine containing materials, and primary amine containing tertiary amines in combination with primary-amine containing materials dramatically decrease the presence of aldehydes and dimethylformamide (DMF) in tertiary amines and tertiary amine blends. Furthermore, foams produced using tertiary amines that contain primary amines, primary amine containing materials, and primary amine containing tertiary amines in combination with primary amine containing materials also have decreased presence of formaldehyde and remarkable reductions in foam odor.

Without being bound by theory, it is believed that an embodiment of the present invention reduces the amount of formaldehyde available to act as an emission from a foam and it reduces the amount of formaldehyde available to undergo the Cannizzaro Reaction. That is, if there is little or no formaldehyde then there is little formic acid formed and even less DMF. Generally, it is believed that a primary amine reacts with an aldehyde to form a Schiff base, which further reacts to a variety of products. In this way, most of the aldehyde is consumed and very-little is available to form the amides such as dimethylformamide.

According to an embodiment of the present invention, the presence of formaldehyde and DMF may be controlled in tertiary amines by the addition of one or more primary amines. Primary amines that may be added to a tertiary amine or a tertiary amine blend, include, but are not limited to, one or more of aminoethylethanolamine, aminopropylmethylethanolamine, dimethylaminopropylamine (DMAPA), diethylenetriamine, dimethylaminoethoxypropylamine (DDP), triethylenetetraamine, aminopropylmethylaminoethanolamine, dimethylaminoethoxypropylamine, tetraethylenepentylamine, dimethylaminopropylaminopropylamine, dimethylaminopropylethoxyethylmethylaminopropylamine, and dimethylaminoethoxyethylmethylaminopropylamine(dimethylaminoethyl methylaminoethoxypropylamine), and tertamethylaminopropylaminopropylamine. Notably, one or more of the primary amines listed in the previous sentence may also include another amine group such as a secondary or tertiary amine in addition to the primary amine.

According to another embodiment of the invention materials containing primary amines may be added to a tertiary amine or blend of tertiary amines to control the presence of formaldehyde and DMF. Urea, melamine, primary amino-containing polyols such as JEFFAMINE® polyether amines, guanidines, substituted ureas, hydroxylamine, phenylhydrazine, semicarbazide, and aniline are all examples of materials that contain a primary amine that may be added to a tertiary amine or a tertiary amine blend, although embodiments are not so limited. For example, any compound containing at least one primary amine group (NH₂) and at least one tertiary amine compound or compound that contains a tertiary amine and a primary amine group may be ideal compounds to serve this function. In fact, any number of the general class of tertiary amines produced from the Michael Addition reaction of an alcohol containing or amino containing tertiary amine would fit this general class of compounds. For instance, a compound having the general formula of (R1)(R2)N-A-B[-M[N—(R3)(R4)]_{g}]_{W} where R1 and R2 may be hydrogen, aliphatic, cycloaliphatic or aryl, A is (CH2)_{y} in which y is an integer from 1 to 8, B is oxygen, nitrogen, or sulfur, M is hydrogen, aliphatic, cyloaliphatic, or an aryl group, g=0 to 3, W=1 if B=oxygen or sulfur or 2 if B=nitrogen, and R3 and R4 may be hydrogen, aliphatic, cycloaliphatic or aryl. Wherein if R1 and R2 are alkyl groups then R3 and R4 are hydrogen, B is nitrogen in this case and if R1 and R2 are hydrogen then R3 and R4 are an alkyl such that the compound will have at least one primary amine and one or more secondary or tertiary amines. Again, one or more of the amines listed above may include another amine such as a secondary or tertiary amine or in addition to the primary amine.

An example of a Michael Addition tertiary amine is dimethylamine plus acrylonitrile---→reduce with hydrogen->yields DMAPA (dimethylaminopropylamine) (CH3)2NCH2CH2CH2NH2.

Another example of a Michael Addition catalyst containing a tertiary amine is dimethylaminopropylamine (DMAPA) plus acrylonitrile→reduce with hydrogen→dimethylaminopropylaminopropylamine (CH3)2NCH2CH2CH2NHCH2CH2CH2NH2.

An example of a Michael Addition to a hydroxyl containing amine is DMEA (dimethylaminoethanol) plus acrylonitrile→reduce with hydrogen→dimethylaminoethoxypropylamine (CH3)2NCH2CH2OCH2CH2CH2NH2.

A further example of a hydroxyl containing catalyst modified with Michael Addition is N,N,N′Dimethylaminoethylmethylaminoethanol plus acylonitrile→reduce with hydrogen→N,N,N′ dimethylaminoethylmethylaminoethoxypropylamine. (CH3)2CH2CH2(CH3)NCH2CH2OCH2CH2CH2NH2.

A further example of a Michael Addition product is tetramethyliminobispropylamine plus acrylonitrile→reduce with hydrogen→bisdimethylaminopropylaminopropylamine.

In yet other embodiments of the present invention, a mixture of one or more primary amine containing tertiary amines and one or more primary amine containing materials may be added to a tertiary amine or tertiary amine blend to reduce the presence of formaldehyde and DMF.

Any tertiary amine containing catalyst or tertiary amine catalyst blend useful in making foams can be the tertiary amine to which a primary amine is added. For example, bisdimethylaminoethylether, dimethylaminoethoxyethylmethylaminoethanol, triethylenediamine, pentamethyldiethylenetriamine, dimethylaminopropyl-S-triazine, dimethylaminoethoxyethanol, N-substituted morpholines such as N-methyl or N-ethylmorpholine, bisdimethylaminopropylurea, hydroxypropyl-tertamethyliminopropylamine, or any other catalyst shown in appendix D of Flexible Urethane Foams, Herrington et al, 1991D.1 through D.17 are suitable tertiary amines, which is incorporated herein by reference.

Very generally, to make polyurethane foam, an isocyanate is reacted with one or more compounds having one or more hydrogen-containing reactive groups. In some embodiments of the invention, the compounds having one or more reactive hydrogens are polyols, although embodiments are not so limited. Furthermore, the isocyanate can be any isocyanate such as toluene disocyannate (TDI) or methylenediisocyanate(MDI), polymeric methylene diisocyanate (PMDI) or variations thereof. Again, foams that are made according to an embodiment of the present invention are not limited in this respect. Other additives that are known to those skilled in the art of producing foams may also be included in a reaction mixture including, without limitation, surfactants, blowing agents, water, fire retardants, color or dye, metal catalyst, and anti oxidants.

Primary amines are good color stabilizers for tertiary amines see, for example, U.S. Pat. No. 7,169,268, which is incorporated herein by reference. Furthermore, primary amine containing materials react with isocyanates 100,000 times faster than primary alcohols. Thus, the addition of catalytic activity in a primary amine molecule is highly desirable. According to an embodiment, this is accomplished by incorporating a tertiary amine group in the primary amine containing molecule. In foam production, these primary amines are rapidly consumed by the isocyanates and produce very high quality low odor foams.

One source of odor in foams may be methylamines. Methylamines are detectable to the human nose at levels as low as 0.4 parts per billion as a fishy ammonia type odor. Very low amounts in foam can lead to odor complaints by the end users. Methylamines may be derived from a number of sources. One source is the simple thermal decomposition of the tertiary amine. Without being bound by theory, tertiary amines can form quaternary compounds that under go Hoffman Eliminations to yield a vinyl material and methyl amine (e.g. trimethylamine), amine oxides to undergo Cope eliminations and a variety of other reactions to yield malodorous materials.

According to an embodiment of the present invention, the inclusion of a tertiary amine that contains a primary amine or a tertiary amine blend that contains a primary amine to a foam formulation eliminates odor caused by methylamines. Furthermore, foams made with such amines show little or no methylamine formation at temperatures above 140° C. while foams made with tertiary amines that do not also include a primary amine produce significant methylamines at such elevated temperatures.

### EXAMPLES

In a typical 1.5 pound per cubic foot (pcf) foam there is about 158 parts or grams of materials. Typical catalyst levels in these foams are about 0.08 parts or 0.08/158-0.05% of the total formulation. So, if the catalyst contains 200 ppm formaldehyde(0.0002) and the catalyst is 0.05% of the formulation there is (0.0002)×(0.0005)=0.0000001 or 0.1 ppm formaldehyde in the foam, which barely meets the standards set by the CertiPUR program. According to an embodiment of the present invention, formaldehyde (and DMF) is greatly reduced in the catalysts and hence the foams produced using the catalysts.

In the following examples, tertiary amines containing known amounts of formaldehyde were treated at room temperature and at ambient pressure with several primary amine containing materials including primary amine containing tertiary amines. The treated tertiary amines were tested for aldehydes using liquid chromatography (LC) method ST-38.40 equipped with a Waters Detector 486UV @ 365 nm using a Restek Pinnacle TO-115 μM 4.6 mm×150 mm column. The LC test was conducted by mixing the test material with dinitrophenylhydrazine and a citric acid buffer solution, and heating at 40° C. for a specified time period. The material was injected into a LC machine as described above. The machine was calibrated against known samples of 1 ppm, 0.1, and 0.01 ppm formaldehyde.

As is shown in the examples below, aldehydes, such as formaldehyde, can be reduced in tertiary amines with no processing requirements other than mixing.

### Example #1

### Control or Neat Catalyst

| | | | | Propional- |
|---|---|---|---|---|
| Catalyst | Formaldehyde | Acetaldehyde | Acetone | dehyde |
| (neat) | ppm | ppm | ppm | ppm |
| JEFFCAT® | 83.4 | 17.986 | 0.049 | 0.638 |
| ZF-20 | | | | |
| amine | | | | |
| catalyst | | | | |
| JEFFCAT® | 50.006 | 19.314 | 0.027 | 0.661 |
| ZF-10 | | | | |
| amine | | | | |
| catalyst | | | | |
| JEFFCAT® | 291.358 | 1.23 | 0.093 | 0.0016 |
| PMDETA | | | | |
| amine | | | | |
| catalyst | | | | |

JEFFCAT® ZF-10 amine catalyst (dimethylaminoethoxyethylmethylaminoethanol), JEFFCAT® ZF-20 amine catalyst(bisdimethylaminoethylether), and JEFFCAT® PMDETA amine catalyst(pentamethyldiethylenetriamine) are all tertiary amine catalysts, available from Huntsman Corporation, The Woodlands, Tex.

### Example #2

### Addition of Amine to Control or Neat Catalyst

| JEFFCAT® | | | | |
|---|---|---|---|---|
| Catalysts | | | | Propional- |
| plus primary | Formaldehyde | Acetaldehyde | Acetone | dehyde |
| amine | ppm | ppm | ppm | ppm |
| JEFFCAT® | 3.415 | 0.948 | 0.189 | 0.039 |
| ZF-20 | | | | |
| plus 10% | | | | |
| DMAPA | | | | |
| JEFFCAT® | 5.029 | 15.315 | 0.237 | 0.443 |
| ZF-10 | | | | |
| plus 10% | | | | |
| DMAPA | | | | |
| JEFFCAT® | 55.722 | 1.067 | 0.424 | 0.138 |
| PMDETA | | | | |
| plus 10% | | | | |
| DMAPA | | | | |
| ZF-20 plus | 69.716 | 1.8 | 0.161 | Nd |
| 10% DDP | | | | |
| ZF-10 plus | 16.218 | 11.424 | 0.035 | 0.371 |
| 10% DDP | | | | |
| PMDETA | 114.031 | 20.005 | 0.039 | 0.404 |
| plus | | | | |
| 10% DDP | | | | |

Dimethylaminopropylamine (DMAPA) and dimethylaminoethoxypropyl-amine (DDP) are primary amines that are available from Huntsman Corporation. JEFFCAT® PMDETA amine catalyst is a tertiary amine catalyst also available from Huntsman Corporation. In this Example, the amine catalysts blended with DMAPA reduced formaldehyde content by a factor of 4 or 5 and the catalysts blended with DDP reduced the formaldehyde content by 50%. Thus, there was a dramatic decrease in formaldehyde content with the treated tertiary amines. It is surprising that the formaldehyde reductions occurred without any heating or any other treatment other than the addition of primary amines to the tertiary amines.

### Example #3

| | Formaldehyde |
|---|---|
| JEFFCAT® amine catalyst plus Primary amine | ppm |
| JEFFCAT® ZF-20 amine catalyst plus 5% AEEA | 57.517 |
| JEFFCAT®ZF-10 amine catalyst plus 5% AEEA | 12.819 |
| JEFFCAT® PMDETA amine catalyst plus 5% AEEA | 266.087 |
| JEFFCAT® ZF-20 amine catalyst plus 5% TEPA | 7.086 |
| JEFFCAT®ZF-10 amine catalyst plus 5% TEPA | 5.155 |
| JEFFCAT® PMDETA amine catalyst plus 5% TEPA | 114.01 |

Aminoethylethanolamine (AEEA) and tetraethylenepentylamine (TEPA) are primary amines available from Huntsman Corporation. In this Example, AEEA reduced the formaldehyde by a factor of four in JEFFCAT® ZF-10 amine catalyst, and TEPA reduced the formaldehyde in JEFFCAT® ZF-20 amine catalyst and JEFFCAT® ZF-10 amine catalyst by a factor of 3 and 9 respectively.

### Example #4

To a different lot of JEFFCAT® ZF-20 amine catalyst(neat), the initial analysis of formaldehyde was found to be 95.3 ppm. Addition of 10% DMAPA to the catalyst dropped the formaldehyde content to 24.7 ppm.

### Example #5

A flexible foam was prepared using the formulation below and was placed in a convection oven at 180° C. for 15 minutes. After removal from the oven, the foam was stored at room temperature for 24 hours. A one gram sample was taken from the foam and placed in a sealed vial with 10 ml of methanol (the methanol had previously been analyzed for formaldehyde and DMF and was found free of both products). The vial was placed in an ultrasonic bath to extract formaldehyde. The samples were submitted for LC for formaldehyde and gas chromatography(GC) for DMF. No DMF was found and the formaldehyde was less than the detection limit of 1 ppm. The foams were stored for 5 days and the process repeated with the same results.

It should be noted that the above is but one embodiment of the present invention. But foams can be made over a wide range of pressures such as from −300 mm Hg to 1000 mm Hg and temperatures such as from −20° C. to 200° C. Generally, if the pressure is reduced, a lower density foam results and if the pressure is increased, a higher density foam results. This is known as the variable pressure process or VP process.

### Formulation:

| Component | Parts |
|---|---|
| VORANOL® CP-3010 polyether polyol | 100.0 |
| Water | 4.5 |
| NIAX® L-620 silicone surfactant | 1.0 |
| JEFFCAT® TD-33A amine catalyst | 0.18 |
| JEFFCAT® ZF-20 amine catalyst | 0.05 |
| (treated with 10% | |
| dimethylaminopropylamine) | |
| KOSMOS® 15 stannous octoate | 0.32 |
| TDI | 58.38 |
| TDI index 112 | |
| Results: | |
| Formaldehyde by LC ppm | 0.465 ppm |
| DMF by GC | not detected |

As is shown from the results above, less than 1 ppm of formaldehyde was detected in the foam. VORANOL® CP 3010 polyether polyol is a glycerin based propylene oxide/ethylene oxide polyether polyol hydroxyl value 56 mgKOH/g manufactured by The Dow Chemical Company of Midland Mich., NIAX® L-620 silicone surfactant is a silicone surfactant manufactured by Momentive Performance materials of Wilton, Conn., JEFFCAT® TD-33A amine catalyst is a 33% solution of triethylene diamine in dipropylene glycol from Huntsman Corporation, KOSMOS® 15 stannous octoate is stannous octoate, a tin catalyst, manufactured by Evonik Degussa GmbH of Essen, Germany, and TDI is 80/20 toluene diisocyanate from The Dow Chemical Company of Midland, Mich.

In the next examples, foams were made using an untreated tertiary amine catalyst or catalyst containing both primary and tertiary amine groups. The foams made with the catalyst containing both primary and tertiary amine groups smelled better that those made with the untreated tertiary amine catalysts and they emitted less dimethylamine when heated.

### Example #6

In this example, foams were made in accordance with the foam of example five, except for the catalysts. For example, in a first foam, the catalysts of example 5 were replaced with an untreated catalyst, and in a second foam the catalysts of example 5 were replaced with a compound that includes both primary and tertiary amine groups. Specifically, the first foam was made using untreated bisdimethylaminoethylether, and the second foam was made using N,N,dimethylaminoethoxypropylamine as the amine catalyst. Both foams were smelled by 10 individuals. Each individual determined which foam, the first foam or the second foam, had more odor and which one had less odor. The results were as follows:

| | MORE ODOR | LESS ODOR |
|---|---|---|
| | (# of | (# of |
| FOAM ACCORDING TO CATALYST | individuals) | individuals) |
| Bisdimethylaminoethylether | 9 | 1 |
| (first foam) | | |
| N,N,dimethylaminoethoxypropylamine | 1 | 9 |
| (second foam) | | |

N,N,dimethylaminoethoxypropylamine and bisdimethylaminoethylether are both available from Huntsman Corporation.

According to the results above, more individuals thought that the foam made with the untreated tertiary amine catalyst had more odor than the foam made with the catalyst having both primary and tertiary amine groups.

### Example #7

In this example, two different types of foams were made using the following general formulation:

| Formulation | PBW |
|---|---|
| B-side: (Resin) | |
| Voranol® CP-3010 polyether polyol | 100.0 |
| Water | 2.8 |
| Niax® L-620 silicone surfactant | 1.0 |
| Kosmos® 15 stannous octoate catalyst | 0.25 |
| Amine catalyst | as required |
| A-side: (isocyanate) | |
| Toluene diisocyanate | 39.12 |
| TDI index 110 | |
| (Ingredient sources are the same as previously noted.) | |

In one type of foam the amine catalyst was a tertiary amine catalyst and in the other type of foam the amine catalyst included both primary and tertiary amine groups. Generally, to make the different foams, the B- or resin side was made by premixing all of the B-side ingredients, except the catalysts, for one hour prior to foaming. Thereafter, the appropriate type and amount of amine catalyst was added to 103.8 grams of resin side. These mixtures were mixed for seven seconds before adding the tin catalyst. The B- or resin side mixtures were then mixed for an additional seven seconds.

TDI was then added to the resin mixtures and mixed for seven seconds. The resultant foams were allowed to rise and cure under ambient conditions for one hour while covered with a polyethylene plastic wrap (to trap odor in the foam).

Immediately thereafter, samples of core foam were taken from the top surface of the different foams and trimmed to weigh 0.20 grams. In most cases 5 foam samples were taken from the top of each foam.

Each 0.20 gram sample of foam was immediately placed in a crimp top vial with a rubber septum. The sealed foam samples were heated from ambient temperature to either 150° C. or 170° C. and held at the desired termperature for an hour. Thereafter, the foam samples were auto-sampled tested by GC head space for emissions of dimethylamine. The results of these tests were as follows:

| | Ppm | Ppm | |
|---|---|---|---|
| Foam according to type of | dimethylamine | dimethylamine | Foam |
| catalyst | at 150° C. | at 170° C. | odor |
| N, N, dimethylamino- | 1.08 | 2.2 | none |
| ethoxypropylamine | | | |
| JEFFCAT®DMEA | 9.5 | 10.5 | Musty/ |
| | | | fishy |

JEFFCAT®DMEA catalyst (dimethylaminoethanol) is available from Huntsman Corporation.

According to the results above, dimethylamine emissions from foam samples heated to 150° C. and to 170° C. were greatly reduced in those samples made using a catalyst containing both primary and tertiary amine groups as compared to samples made with a tertiary amine catalyst without a primary amine group. Furthermore, an unpleasant odor was not detected in those samples made using the catalyst including both a primary and a tertiary amine group.

Consideration must be given to the fact that although embodiments of this invention have been described and disclosed in relation to certain embodiments, equivalent modifications and alterations thereof will become apparent to one of ordinary skill in the art upon reading and understanding this specification and the claims appended hereto. Accordingly, the present invention is intended to cover all such modifications and alterations.

What is claimed is:

1. A method comprising:
adding, a primary amine containing compound to a tertiary amine catalyst, said tertiary amine catalyst containing a quantity of formaldehyde; and
in response to said adding, reducing the quantity of formaldehyde in said tertiary amine catalyst by at least fifty percent.

2. The method of claim 1 wherein reducing the quantity of formaldehyde in said tertiary amine catalyst includes reducing the quantity of formaldehyde in said tertiary amine catalyst by a factor of 3 to 9.

3. The method of claim 1 wherein reducing the quantity of formaldehyde includes reducing the quantity of formaldehyde to less than or equal to 57.5 parts per million.

4. The method of claim 1 wherein adding said primary amine containing compound to said tertiary amine catalyst includes adding said primary amine containing compound in an amount such that it comprises from 0.01% to 30% of the primary amine containing compound and said tertiary amine catalyst mixture.

5. The method of claim 1 wherein adding a primary amine containing compound to a tertiary amine catalyst includes adding one or more of aminoethylethanolamine, diethylenetriamine, triethylenetetraamine, tetraethylenepentylamine, aminopropylmethylaminoethanolamine, dimethylaminopropylamine, dimethylaminoethoxypropylamine, dimethylaminopropylaminopropylamine, dimethylaminopropylethoxyethylmethylaminoproylamine, aminopropylmethylethanolamine, a primary amino-containing polyol, guanidine, urea, a substituted urea, hydroxylamine, phenylhydrazine, semicarbazide, melamine, or aniline to add to the tertiary amine.

6. The method of claim 1 wherein adding a primary amine containing compound to a tertiary amine catalyst includes adding one or more compounds that are a Michael Addition product of an tertiaryaminoalcohol or tertiary amino amine having the general structure of:
(R1)(R2)N-A-B[-M[N—(R3)(R4)]_{g}]_{W}
wherein each of R1 and R2 is hydrogen, aliphatic, cycloaliphatic or aryl, A is (CH2)_{y} in which y is an integer from 1 to 8, B is oxygen, nitrogen, or sulfur, M is hydrogen, aliphatic, cyloaliphatic, or an aryl group, g=0 to 3, W=1 if B=oxygen or sulfur or 2 if B=nitrogen, and each of R3 and R4 is hydrogen, aliphatic, cycloaliphatic or an aryl group and wherein when R1 and R2 are alkyl groups then R3 and R4 are hydrogen, M is nitrogen in this case and if R1 and R2 are hydrogen then R3 and R4 are an alkyl such that the compound will have at least one primary amine and one or more secondary or tertiary amines.

7. The method of claim 1 wherein adding a primary amine containing compound to a tertiary amine catalyst includes adding a primary amine containing compound to at least one of triethylenediamine, bisdimethylaminoethylether, dimethylaminoethoxyethylmethylaminoethanol, pentamethyldiethylenetriamine, hydroxylpropyltetramethylimnobispropylamine, tertamethylimnobispropylamine, substituted morpholines, N-methylmorpholine, N-ethylmorpholine, N-butlymorpholine, substituted imidazoles, dimethylimidazole, aminoethylimidazole, aminopropylimidazole, 1 aminopropyl 2-methyl imdiazole, substituted piperadines, N,N-dimethylpiperazine, N-methylaminoethylpiperazine, N-methylaminopropylpiperazine, a substituted urea, dimethylaminopropylurea, bis-dimethylaminopropylurea, dimethylaminopropyl(3-dihydroxypropyl)amine.

8. The method of claim 1 wherein adding includes, without heating, adding said primary amine containing compound to said tertiary amine catalyst.

9. The method of claim 1 wherein adding a primary amine containing compound to a tertiary amine catalyst includes adding dimethylaminopropylamine to bisdimethylaminoethylether to reduce the quantity of formaldehyde in said bisdimethylaminoethyletherby a factor of 4.

10. The method of claim 1 wherein adding a primary amine containing compound to a tertiary amine catalyst includes adding tetraethylenepentylamine to bisdimethylaminoethyletherto reduce the quantity of formaldehyde in said bisdimethylaminoethyletherby a factor of 3.

11. A method comprising:
combining a compound containing a reactive hydrogen and a tertiary amine catalyst that is useful to the production of a polyurethane foam, said tertiary amine catalyst treated, at room temperature and pressure, with a primary amine containing compound such that said primary amine containing compound reduces the quantity of formaldehyde in said tertiary amine catalyst by at least a factor of 4;
causing an isocyanate and said compound containing a reactive hydrogen to form a polyurethane foam; and
in response to the presence of said treated tertiary amine catalyst, reducing the formaldehyde emitted from said polyurethane foam to an amount that is acceptable according to the CertiPUR standard.

12. The method of claim 11 wherein reducing the formaldehyde emitted from said polyurethane foam includes detecting less than 1 ppm formaldehyde via chromatography.

13. The method of claim 11 including in response to the presence of said treated tertiary amine catalyst, reducing the dimethylformamide emitted from said polyurethane foam to an undetectable amount via gas chromatography.

14. The method of claim 11 wherein treating said tertiary amine catalyst includes adding one or more of aminoethylethanolamine, diethylenetriamine, triethylenetetraamine, tetraethylenepentylamine, aminopropylmethylaminoethanolamine, dimethylaminopropylamine, dimethylaminoethoxypropylamine, dimethylaminopropylaminopropylamine, dimethylaminopropylethoxyethylmethylaminoproylamine, aminopropylmethylethanolamine, a primary amino-containing polyol, guanidine, urea, a substituted urea, hydroxylamine, phenylhydrazine, semicarbazide, melamine, or aniline to said tertiary amine catalyst.

15. The method of claim 11 wherein treating said tertiary amine catalyst includes adding one or more compounds that are a Michael Addition product of an tertiaryaminoalcohol or tertiary amino amine having the general structure of:
(R1)(R2)N-A-B-A-N(R3)(R4)
wherein R1 and R2 are either i) a hydrogen or ii) an alkyl having from 1 to 8 carbons, B is one of oxygen, sulfur, or nitrogen, A is (CH₂)ₓ in which x is an integer from 1 to 8, and R3 and R4 are either i) hydrogen or ii) an alkyl having from 1 to 4 carbons, and wherein if R1 and R2 are alkyl groups then R3 and R4 are hydrogen and if R1 and R2 are hydrogen then R3 and R4 are an alkyl groups such that the Michael Addition product has at least one primary amine and at least one tertiary amine to said tertiary amine catalyst.

16. The method of claim 11 wherein combining a compound containing a reactive hydrogen and a tertiary amine catalyst that is useful to the production of a polyurethane foam includes combining at least one of triethylenediamine, bisdimethylaminoethylether, dimethylaminoethoxyethylmethylaminoethanol, pentamethyldiethylenetriamine, hydroxylpropyltetramethylimnobispropylamine, tertamethylimnobispropylamine, substituted morpholines, N-methylmorpholine, N-ethylmorpholine, N-butlymorpholine, substituted imidazoles, dimethylimidazole, aminoethylimidazole, aminopropylimidazole, 1 aminopropyl 2-methyl imdiazole, a substituted piperadines, N,N-dimethylpiperazine, N-methylaminoethylpiperazine, N-methylaminopropylpiperazine, a substituted urea, dimethylaminopropylurea, bis-dimethylaminopropylurea, dimethylaminopropyl(3-dihydroxypropyl)amine with said compound containing a reactive hydrogen.

17. The method of claim 11 wherein treating said tertiary amine catalyst with a primary amine containing compound includes treating said tertiary amine with a tertiary amine that also has a primary amine group, and wherein said treated tertiary amine that contains a primary amine catalyst is from 0.01% to 100% of the catalyst used to make said foam with reduced odor.

18. The method of claim 11 wherein reducing the formaldehyde emitted from said polyurethane foam to an amount that is acceptable according to the CertiPUR standard includes reducing the formaldehyde and emitted from said polyurethane foam to less than 1 ppm formaldehyde and dimethylformamide to meet the CertiPUR specification.

19. A method for making a polyurethane foam that, at temperatures exceeding 140° C., has low-odor and low dimethylamine emissions comprising:
combining an A-side with a B-side, said A-side including an isocyanate and said B-side including an isocyanate-reactive material together with N,N,dimethylaminoethoxypropylamine; and
allowing said A-side and said B-side to react to form said polyurethane foam.

20. The method of claim 19 including heating said polyurethane foam to both 150° C. and 170° C. without detecting an odor resulting from dimethylamine.
